(19) United States
(12) Patent Application Publication
(10) Pub. No.: US 2024/0299129 A1
(43) Pub. Date: Sep. 12, 2024

(54) WATER SUPPRESSION SYSTEM FOR DENTAL AIR-PARTICLE SURFACE TREATMENT SYSTEMS

(71) Applicant: Boaz Barry Groman, Boca Raton, FL (US)

(72) Inventor: Boaz Barry Groman, Boca Raton, FL (US)

(21) Appl. No.: 18/600,722

(22) Filed: Mar. 10, 2024

Related U.S. Application Data
(60) Provisional application No. 63/451,225, filed on Mar. 10, 2023.

(51) Int. Cl. A61C 3/025

(52) U.S. Cl. CPC A61C 3/025

(57) ABSTRACT

A water source having a flexible tube for discharging water is provided for use in conjunction with a micro-abrasive blasting device so that water may be dispensed onto or around or in close proximity with the distal end or tip of the discharge conduit of said device to generate a water mist for suppressing powder aeration when dental procedures such as abrasion or polishing procedures are being performed. The water source may be separate from or self-contained with the micro-abrasive blasting device. An overlay water nozzle may be used to position distal ends of the flexible tube and discharge conduit in close proximity with one another.

### CROSS-REFERENCE TO RELATED APPLICATIONS

This is a nonprovisional filing of 63/451,225 filed 10 Mar. 2023, incorporated in its entirety by reference herein.

### TECHNICAL FIELD

The invention relates generally to the field of devices for propelling (blasting) powder with intent to polish or abrade (such as etch) the surface of a target material (such as a tooth). More specifically, the present invention relates to an air polishing or air abrasion (such as micro-abrasive) blasting device powered by a pressurized-gas source for use with dental procedures. More specifically, the invention relates to providing a water source in conjunction with the dental abrasive blasting device.

### BACKGROUND

Abrasive blasting devices operate on the physical property that gas at a higher pressure flows towards and into gas at lower pressure. When abrasive powder is mixed with gas at higher pressure, the gas carries the abrasive powder as the gas accelerates and flows to the lower pressure. As the gas and abrasive powder blast the target material at high speed, the impact of the particles removes layers of the target material.

In dentistry this technology is known as micro-abrasion and is used to achieve a variety of goals—such as to remove foreign material or to dull a shiny surface, roughen or etch the surface to enhance bonding quality and to remove decay by drilling and cutting tooth structure.

When mild powder is used in micro-abrasion devices, the target surface is not abraded but rather is polished. Such powders are used in prophylaxis procedures where the intent is for the removal of extrinsic stain, dental plaque and soft debris while simultaneously polishing tooth surfaces. Such procedures normally use sodium bicarbonate and calcium carbonate types of powders.

The following US patents and publications are illustrative of some dental micro-abrasive blasting devices (or tools) which may be disposable and to which the present invention may be applicable (or adapted), and are incorporated by reference herein.

| | | |
|---|---|---|
| 9,050,156 | Jun. 9, 2015 | Groman |
| 8,632,378 | Jan. 21, 2014 | Groman |
| 8,529,313 | Sep. 10, 2013 | Groman |
| 8,360,826 | Jan. 29, 2013 | Groman |
| 8,241,094 | Aug. 14, 2012 | Groman |
| 20120171636 | Jul. 5, 2012 | Groman |
| 7,927,188 | Apr. 19, 2011 | Groman |
| 7,731,570 | Jun. 8, 2010 | Groman |
| 7,607,972 | Oct. 27, 2009 | Groman |

Water is used by dental professionals to wash away particles during oral procedures. The water at the dental chair can come from tap water or pressurized water bottles. Dental water lines require continuous cleaning to avoid contamination due to water borne contaminates. Many devices and chemicals are available for maintaining dental water systems.

Dental devices that use abrasive and polishing powders for treating tooth surfaces for abrasion or polishing have long been using the dental water supply to suppress the aeration of expressed powders during delivery. Since the dental water supply is set to 40-50 psi of pressure, dental devices that utilize the dental chair water require pressure and flow controls to reduce and adjust the water stream. These devices require substantial maintenance and cleaning procedures between patients to prevent cross contamination.

### SUMMARY

In the main, hereinafter, a micro-abrasive blasting device may be referred to simply as a “device”, and said device may be handheld and may be used to perform dental procedures such as abrasion or polishing procedures such as, but not limited to cavity prep, micro etching, and prophylaxis procedures. Said procedures may result in powder aeration in the vicinity of the target area (e.g., tooth) being treated.

It is an object of the invention(s) disclosed herein to provide techniques for incorporating delivering water in conjunction with a handheld dental tool, or micro-abrasive (air abrasion) blasting device, such as the micro-abrasive blasting devices mentioned above. This may include (i) providing a water source mounted to the micro-abrasive blasting device or, alternatively, (ii) providing means for connecting an external water source to the micro-abrasive blasting device. Both alternatives may be discussed below.

It is an object of the invention disclosed herein, in its various embodiments, to provide improvements in methods of performing dental perform dental procedures such as abrasion or polishing procedures such as, but not limited to cavity prep, micro etching, and prophylaxis procedures by reducing powder aeration in the vicinity of the target area (e.g., tooth) being treated.

Generally, an exemplary handheld micro-abrasive blasting device to which the present invention is well-suited may comprise;
a mixing chamber 23 having a wall 25 with an inlet port 27 and a discharge port 29;
particulate matter 50 disposed within the mixing chamber;
a delivery conduit 30 joined at its proximal end to the inlet port of the mixing chamber; and
a discharge conduit (or nozzle) 10 extending at its proximal end through the discharge port into the mixing chamber.

In use, compressed air may be provided to a distal end of the delivery conduit, said compressed air entering the mixing chamber, and agitating the particulate matter within the mixing chamber so that a stream of particulate matter mixed with air may be ejected from a distal end or tip of the discharge conduit upon a surface being treated.

According to the invention, generally, a water source is provided for use in conjunction with a micro-abrasive blasting device so that the water may be dispensed onto or around or in close proximity with the distal end or tip of the discharge conduit of said device to generate a water mist for suppressing powder aeration (including detritus from the tooth being treated) when dental procedures such as abrasion or polishing procedures are being performed.

According to some embodiments of the invention, a “self-contained” water source is provided for use with air abrasion/polishing devices (for cavity prep, micro etching, and prophylaxis procedures) such that, in use, water is dispensed onto the nozzle of said devices to generate a water mist for suppressing powder aeration where the water dispensing action is activated and generated directly by the air powering the device.

As used herein, the term “self-contained” may mean that the water supply is separate from the dental chair. In the FIG. 3 embodiment, a water supply (320) is provided in conjunction with the air-abrasive tool (310). Water is caused to exit the water supply when there is a pressure drop caused by air (and abrasive) exiting the air-abrasive tool 310. In the FIG. 2 embodiment, a water supply (220) is provided in conjunction with and mounted to (integral with) the air-abrasive tool (210). In the FIG. 2 embodiment, the water supply is shown receiving pressurized air from the dental chair. However, the FIG. 2 embodiment may work without receiving pressurized air from the dental chair, based on a pressure drop as illustrated by the FIG. 3 embodiment. The FIG. 2 embodiment shows the water supply is attached to the air-abrasive tool. The FIG. 3 embodiment shows the water supply is separate from (not attached to) the air-abrasive tool. In the FIG. 2 embodiment, the water supply is shown as being similar to a syringe, with a plunger. In the FIG. 3 embodiment, the water supply is shown as being similar to an IV bag. The FIG. 4 embodiment operates in a manner similar to that of the FIG. 3 embodiment, that is, without relying on air pressure or water from the dentist's chair. In the FIG. 4 embodiment, a end portion of the discharge conduit of the air-abrasive device 402 is shown piercing an end portion of a flexible tube 406 delivering water from a cartridge containing water at atmospheric pressure (similar to the FIG. 3 embodiment) so that the water and abrasive can be delivered to the same area of a target (tooth).

The FIG. 5A,B embodiment shows an overlay water nozzle 500 for combining the water and abrasive for delivery to the same area of a target (tooth).

According to some embodiments of the invention, the water source may be supplied at atmospheric pressure water from a supply which is either mounted to (as shown in FIGS. 2, 4) or external to (as shown in FIG. 3) the micro-abrasive blasting device.

According to some embodiments of the invention, water dispensing action may be activated and generated directly by the air powering the micro-abrasive blasting device (as shown in FIGS. 3, 4) so that micro-abrasive (air) delivery and water delivery are synchronized with one another.

According to some embodiments of the invention, the water source is not self-contained. Rather the water may be a supply of pressurized water from a dental chair. Using an independent water source such as a syringe mounted to the micro-abrasive blasting device makes the system cumbersome, and dentists already put substantial effort into keeping their water clean. An adjustable valve may be incorporated to balance the supply water pressure so the pressure drop at the nozzle (discharge conduit of the micro-abrasive blasting device) triggers a controlled water flow from the dental chair.

The micro-abrasive blasting device may be disposable. An atmospheric pressure water supply which is mounted to (FIGS. 2, 4) or external to (FIG. 3) the micro-abrasive blasting device may similarly be disposable.

The techniques (apparatus, method, system) disclosed herein provide for water suppression from a source (supply) of water, in conjunction with a handheld dental tool such as an air abrasion/polishing unit handpiece used for air-particle surface treatment systems.

Other objects, features and advantages of the invention(s) disclosed herein, and their various embodiments, may become apparent in light of the descriptions of some exemplary embodiments presented herein.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be exaggerated, others may be omitted, for illustrative clarity. Some figures may be in the form of diagrams.

Although the invention may be described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

FIGS. 1A, 1B are cross-sectional views of a micro-abrasive mixing device with a spherical mixing chamber, according to the prior art (FIGS. 5A and 5B of U.S. Pat. No. 7,607,972).

FIG. 1C is a perspective view of the micro-abrasive mixing device of FIGS. 1A,B in a connector being held by a dentist, according to the prior art (FIG. 5C of U.S. Pat. No. 7,607,972).

FIG. 2 is a diagram of a micro-abrasive blasting system comprising a micro-abrasive mixing device and a water supply mounted thereto, for performing a dental procedure on a patient, according to an embodiment of the invention.

FIG. 3 is a diagram of a micro-abrasive blasting system comprising a micro-abrasive mixing device and a water supply which is not mounted to the device, for performing a dental procedure on a patient, according to an embodiment of the invention.

FIG. 4 is a simplified diagram of a micro-abrasive blasting system comprising a micro-abrasive mixing device and an external water supply, for performing a dental procedure on a patient, according to an embodiment of the invention. It may be noted that FIG. 3 of provisional 63/451,225 is a photograph showing a detailed view of the tip (discharge nozzle) of the micro-abrasive mixing device inserted into a distal end of the flexible tube carrying water, such as is illustrated in FIG. 4 herein.

FIGS. 5A,B are illustrations of an “overlay water nozzle”, wherein distal ends of a flexible tube supplying water and a discharge conduit (nozzle) supplying abrasive material and air are joined (combined) with one another at their distal end portions by a tube attachment for delivering water and air (with abrasive) to a target, according to an embodiment of the invention. FIG. 5A is a “see through” view, and FIG. 5B is a cross-sectional view.

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein. Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

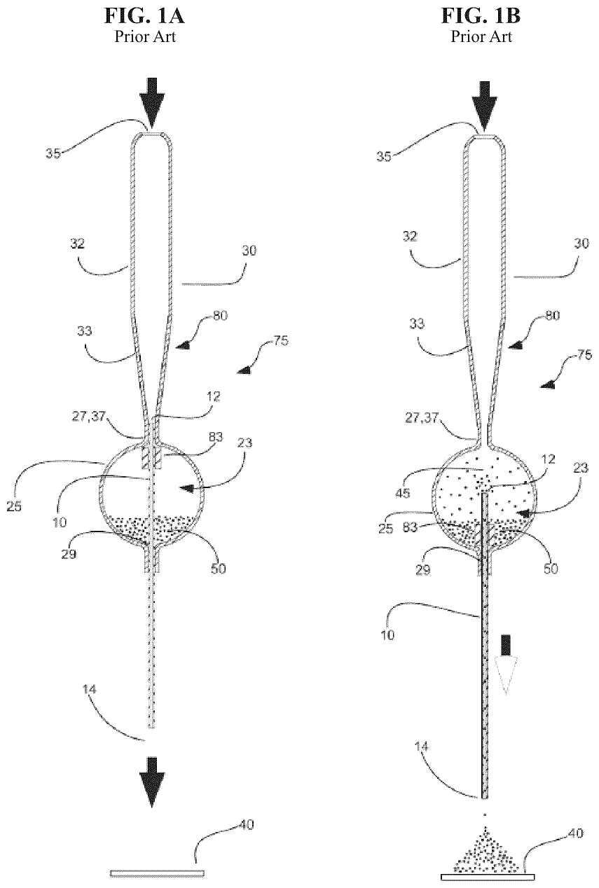

FIGS. 1A,B show a micro-abrasive blasting device 75. The micro-abrasive blasting device 75 comprises a mixing chamber 23 formed by a mixing chamber wall 25 and supports a inlet port 27 and a discharge port 29; a delivery conduit 30 extending from a delivery conduit inlet 35 external to mixing chamber 23 to a delivery conduit outlet 37 internal to mixing chamber 23, by means of protruding into mixing chamber 23 through mixing chamber wall 25 at inlet port 27; a discharge conduit 10 is in fluid communications with mixing chamber 23 at discharge port 29, and extending from a discharge conduit inlet 12 internal to mixing chamber 23 to a discharge conduit outlet 14 external to mixing chamber 23; a particulate matter 50 is disposed within mixing chamber 23.

Delivery conduit 30 comprises a delivery conduit external section 32 external to mixing chamber 23 and a delivery conduit internal section 34 internal to mixing chamber 23 and a connecting delivery conduit tapered section 33; external section 32 of delivery conduit 30 is preferably straight and preferably supports an outer and inner diameter that fits into standard tube and hose connectors such as push-in or push-on connector types; internal section 34 of delivery conduit 30 preferably supports an inner diameter that is equivalent to the outer diameter of discharge conduit inlet 12.

The micro-abrasive blasting device 75 may be constructed as a contiguous pipette structure 80 having a mixing chamber wall 25 constructed to form a hollow spherical bulb mixing chamber 23. The spherical shape of mixing chamber 23 assures a distal separation between the discharge conduit inlet 12 and the particulate matter 50 at all orientations of mixing chamber 23.

Referring to FIG. 1A, discharge conduit inlet 12 abuts delivery conduit outlet 37 as to prevent particulate matter 50 from exiting mixing chamber 23, thereby sealing particulate matter 50 within mixing chamber 23. As delivery conduit external section 32 engages with a pressurized-gas source, pressurized-gas is delivered to delivery conduit 30 at delivery conduit inlet 35; the pressurized-gas passes through delivery conduit 30 into discharge conduit 10 to exit micro-abrasive blasting device 75 at discharge conduit outlet 14. Since discharge conduit inlet 12 abuts delivery conduit outlet 37 the pressurized gas can not enter mixing chamber 23. Therefore, any moisture or liquid residue contained in or carried by the pressurized-gas does not enter mixing chamber 23 and is discharged through micro-abrasive blasting device 75. Stated otherwise, the discharge conduit is movable to selectively allow and block abrasive material from leaving the mixing chamber.

Referring to FIG. 1B, a separation gap 45 between the delivery conduit outlet 37 and discharge conduit inlet 12 is created as discharge conduit 10 is displaced so discharge conduit inlet 12 no longer abuts delivery conduit outlet 37; As pressurized-gas is supplied to micro-abrasive blasting device 75 through delivery conduit inlet 35, the pressurized-gas flows through delivery conduit 30 and out of delivery conduit outlet 37 into mixing chamber 23. When gas flow is present, particulate matter 50 instantaneously mixes with the flowing gas and is dispensed through discharge conduit 10 to strike target surface 40. Once mixing chamber 23 is depleted of particulate matter 50, micro-abrasive blasting device 75 is removed from the pressurized-gas source and discarded.

A discharge conduit stop 83 is attached to discharge conduit 10 so discharge conduit stop 83 moves with discharge conduit 10 within mixing chamber 23 from inlet port 27 to discharge port 29.

FIG. 1C illustrates that the delivery conduit 30 may be connected to a handheld pressurized-gas supply connector 55. Therefore, the micro-abrasive blasting device 75 may be mounted as a disposable tip onto a non-disposable handheld supply connector 55. While handheld supply connector 55 is held by the user's fingertips, delivery conduit 30 of micro-abrasive blasting device 75 mounts into handheld supply connector 55 downstream of the user's fingertips.

Reference may be made to U.S. Pat. No. 7,607,972, incorporated in its entirety by reference herein, for further details about the construction and use of the micro-abrasive blasting device 75.

The following terminology may be used in the present patent application:
the delivery conduit 30, a passage providing compressed air to the mixing chamber 23
the delivery conduit inlet 35 may be referred to as the distal end of the delivery conduit
the delivery conduit outlet 37 may be referred to as the proximal end of the delivery conduit
the discharge conduit 10 may be referred to as a “nozzle”
discharge conduit inlet 12 may be referred to as the proximal end of the discharge conduit
discharge conduit outlet 14 may be referred to as the distal end or tip of the discharge conduit

Powders or other particulate matter may be used in the micro-abrasive devices for abrading or polishing tooth surfaces. The differences between polishing and abrading is generally related to what materials the device is filled with, and how much. Otherwise, a “micro-abrasive” device could function as an “air-polishing” device, and vice-versa. When “abrasive” is used herein, it is intended to cover polishing powders. For purposes of the description of the devices set forth herein, abrasive powders may be considered to be interchangeable with polishing powders.

By way of summary, for example (and without limitation), a micro-abrasive dental blasting device may comprise:
a mixing chamber (23) comprising a wall, an inlet port (27) disposed in the wall and a discharge port (29) disposed in the wall;
a gas delivery conduit (30) extending from external (outside of) the mixing chamber at least to the inlet port (27) and, in some embodiments, to within the mixing chamber, and terminating with a delivery conduit outlet (37); and
a discharge conduit (10) extending from internal (inside of) the mixing chamber, through the discharge port, to external the mixing chamber, and having a discharge conduit inlet (12) disposed within the mixing chamber, and having a discharge conduit outlet (14);
wherein the discharge conduit (10) is movable and, in a first position the discharge conduit inlet (12) abuts the inlet port (27), to seal abrasive material (50, particulate matter) in the mixing chamber until (before) use (in other words, when the device is not being used), in a second position the discharge conduit inlet does not abut the inlet port, to release powder.

In the first position, with the discharge conduit inlet abutting the delivery conduit outlet, air supplied to the gas delivery conduit “bypasses” the mixing chamber, exiting directly through the discharge conduit. This allows for selective delivery of abrasive from the micro-abrasive blasting device.

FIGS. 1-5 of provisional application No. 63/451,225 (which may be referred to hereinafter as the “provisional” or “provisional application”) illustrate an exemplary embodiment of a SELF-CONTAINED WATER SUPPRESSION SYSTEM FOR AIR-PARTICLE SURFACE TREATMENT SYSTEMS of the present invention. Some of the figures presented therein may be reproduced herein.

FIG. 1 of the provisional application is an illustration showing a syringe (cartridge, reservoir) mounted (such as with a bracket) to a handheld dental tool (air abrasion device), showing a syringe with water, a pinch valve for flow control. In this illustration, there is no air flow through the air abrasion device, Thus there is no pressure differential on the water in the cartridge, and no flow of water through the flexible tube. No abrasive is being delivered, and no water is being delivered.

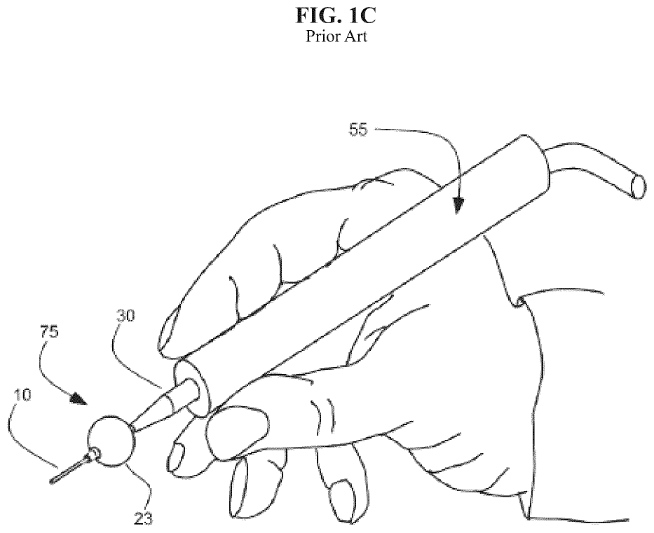

FIG. 2 of the provisional application is an illustration showing the syringe (cartridge, reservoir) of FIG. 1. In this illustration, air is flowing from the air nozzle (tip) of the handheld dental tool (air abrasion device), resulting in a pressure differential on the water in the syringe which will move the plunger and cause water to flow through the flexible tube and exit along with abrasive material from the air abrasion device. Abrasive is being delivered, and water is being delivered.

FIGS. 1 and 2 of the provisional application also show that the flexible tube passes through a clamp which can be adjusted to regulate the amount of water exiting the flexible tube along with air/abrasive when the air abrasive device is operating.

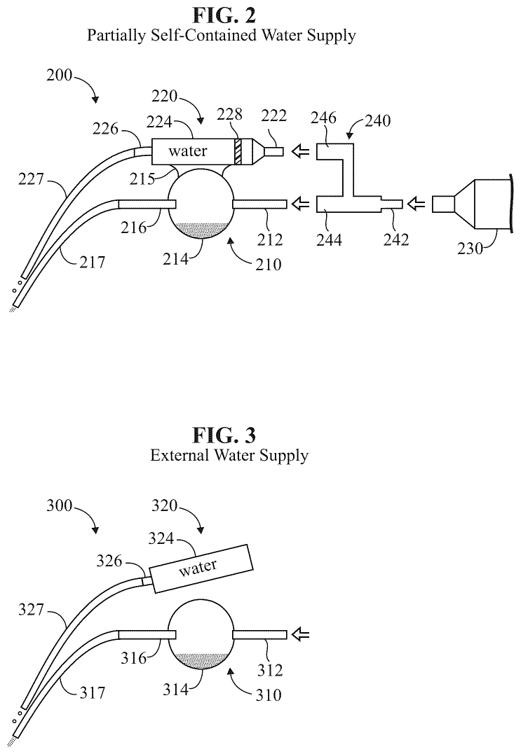

FIG. 3 of the provisional application is an illustration showing a close-up view of how the air nozzle (tip) of the air abrasion device inserted (recessed) into the flexible (water delivery) tube, near the distal end thereof, and shows a close-up view of how the air nozzle (tip) of the air abrasion device may be inserted (recessed) into the flexible (water delivery) tube, near the distal end thereof.

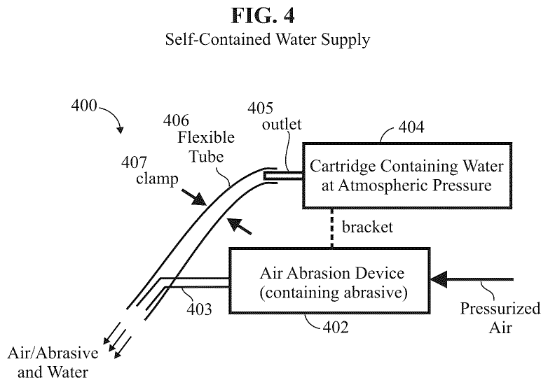

FIG. 4 of the provisional application is a diagram illustrating the air abrasive system with self-contained water supply, and may be reproduced as FIG. 4 herein.

These figures of the provisional application show a water reservoir, which may be in the form of a cylindrical syringe, mounted to (atop) the handheld dental tool. Water exits the syringe through a flexible small diameter water-delivery tube which extends from the front (delivery end) of the syringe to a position in front of an abrasive-containing reservoir of the handheld dental tool. More particularly, the end of the water-delivery tube is substantially coincident with the abrasive-delivery end of the needle of the handheld dental tool. A pinch valve for flow control is shown mounted to (atop) the handheld dental tool. The water-delivery tube passes through the pinch valve, allowing the user (dentist) to turn the water on and off.

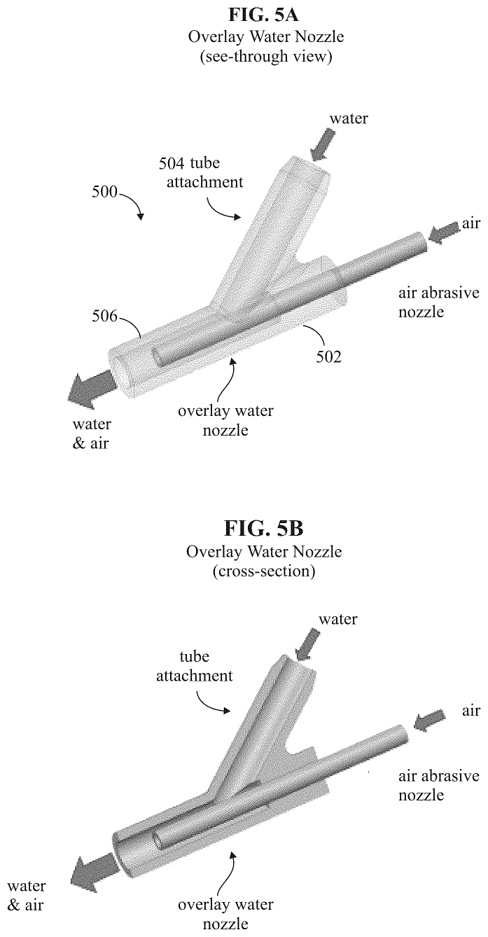

FIGS. 5A,B of the provisional application show an overlay water nozzle for locating the distal end of the air abrasion delivery conduit water delivery tube with the distal end of the water delivery tube, and may be reproduced as FIGS. 5A,B herein.

FIG. 2 of this patent application illustrates an air-abrasive water suppression system 200 for performing a dental procedure on a patient. The system generally comprises:
a “tip” component 210 for delivering abrasive material; and
a water source component 220 for delivering water.

The tip component 210 and the water source component 220 may both be plastic molded and disposable (single-use). And they may be associated (co-located and releasably connected) with one another by a web 215, or clip, or other suitable means. In this embodiment, the water source component (water supply) is mounted to the tip component and is partially “self-contained” in that is has its own water supply, and is not dependent on chair-side water. However, it is not entirely self-contained since it uses chair-side compressed air.

The “tip” component 210 may correspond to the micro-abrasive dental blasting device 75 described hereinabove and may comprise:
a gas delivery conduit 212 (corresponding to delivery conduit 30, hereinabove);
a mixing chamber 214 (corresponding to mixing chamber 23, hereinabove); and
a discharge conduit 216 (corresponding to discharge conduit 10, hereinabove).

The gas delivery conduit 212 receives compressed air from a chairside source (not shown), and provides pressurized air to the mixing chamber, which may be at least partially filled with a quantity of abrasive powder (shown as little black dots in the mixing chamber). When the powder is aerated, it may be discharged through the discharge conduit, such as onto a patient's tooth (not shown).

The discharge conduit 216 may be movable to selectively seal abrasive powder within the mixing chamber or allow the abrasive powder to exit the mixing chamber, as described above with respect to FIGS. 1A and 1B.

The tip component 210 may attach directly via its gas delivery conduit to an adaptor 230 (corresponding to handheld supply connector 55, hereinabove); which receives pressurized air from a pressurized air source (not shown) associated with a dental chair (not shown). The arrow (pointing left) at the outlet (right side) of the adaptor indicates air flow.

Flow of pressurized air from the air source, through the adapter, and through the tip component may be controlled (regulated) by the dentist's chair foot pedal (not shown).

The mixing chamber 214 may be pre-filled with non-abrasive polishing powders such as Sodium Bicarbonate or sodium-free Calcium Carbonate, and may nevertheless be referred to herein as “abrasive” powders. Other materials may include Aluminum Oxide & Glass beads, as well as proprietary materials such as Co-Jet (3M) and OSSpray (bioactive calcium sodium phosphosilicate material that closely resembles natural tooth mineral). See, for example, U.S. Pat. No. 7,329,126 (2008 Feb. 12; Cook et al.), incorporated by reference herein. The polishing powder may include a numbing agent, a bonding agent, or the like.

Generally, the system 200 as described thus far may provide for full mouth waterless prophy treatment (dental prophylaxis) to remove extrinsic stain, dental plaque and soft debris while simultaneously polishing tooth surfaces. Integrated chairside QD HVE (quick disconnect, high velocity evacuation) and handpiece air supply may provide minimal overspray and precise control in a single-handed operation.

The system 200, namely the water portion 220 (i.e., reservoir 224) of the system, may be considered to be “partially” self-contained, in that, although mounted to the air-abrasive tip component 210, the water portion 220 utilizes externally-supplied air pressure to operate.

Generally, dental prophylaxis may be performed on transitional or permanent dentition which includes scaling and polishing procedures to remove coronal plaque, calculus and stains. Some patients may require more than one appointment or one extended appointment to complete a prophylaxis.

Water suppression for generating a water mist for suppressing powder aeration is well known and utilized. Water flow is generated from the dental chair from a water source with some valve arrangement for finger of foot control, plus a pressure regulator. Typically turning on the air leads to a triggering of the water valve. The present invention provides beneficial alternatives to these known techniques such as, but not limited to, providing a self-contained water supply (water source component) associated with the micro-abrasive delivery device.

### Water Source Component

The water source component 220 may be used in conjunction with the tip component 210 to deliver water during treatments with abrasive material, and may comprise:
a gas delivery conduit 222;
a fluid reservoir 224; and
a discharge conduit 226.

The gas delivery conduit 222 provides pressurized air to the fluid reservoir 224, which may be at least partially filled with a volume of water (“water”). Pressurized air supplied to the gas delivery conduit will cause water to be discharged from the discharge conduit 226.

The fluid reservoir 224 may be in the form of a rigid tube (cylinder) having a length, a diameter and two opposite ends, similar to the tube of a syringe.

An inlet (delivery conduit) 222 may be provided at one (right, as viewed) of the ends of the cylinder. The inlet end may be adapted to receive pressurized air from an external source (not shown), such as a dentist's chair.

An outlet (discharge conduit) 226 may be provided at the opposite (left, as viewed) end of the cylinder.

A rubber plunger 228 may be provided in the interior (provided inside) of the cylinder, similar to the plunger of a syringe. The rubber plunger 228 may be movable, in response to external forces (pressures), bi-directionally, between the inlet and outlet ends of the cylinder.

The water source tube 227 may be flexible and is in fluid communication with the outlet end of the water source to discharge water contained within the water source. This may be in response to air pressure applied at the inlet end, causing water disposed between the plunger and the outlet end to move towards the outlet end.

When using a syringe as the water source, it may be possible to provide (ship) the water component 220 without water in it and, prior to use, the user could fill the syringe with water.

A splitter component 240 is shown having an inlet 242 and two outlets 244 and 246.
The inlet 242 of the splitter component may releasably connect (by interference fit, or the like) to an outlet of the adaptor 230 so as to receive pressurized air therefrom.
The outlet 244 of the splitter component may releasably connect (by interference fit, or the like) to the delivery conduit 212 of the tip component 210 so as to deliver pressurized air thereto.
The outlet 246 of the splitter component may releasably connect (by interference fit, or the like) to the delivery conduit (inlet end) 222 of the water source component 220 so as to deliver pressurized air thereto.

Pressurized air supplied to the inlet of the splitter component may be directed to the two outlets.

A flexible extension tube 217 may optionally be attached to and extend from the discharge conduit 216 of the abrasive delivery portion 210 of the system 200, or may be formed integrally therewith. Abrasive material (shown as little dots) is shown being ejected from the flexible extension tube 217.

A flexible extension (water delivery) tube 227 (or micro-tube) may optionally be attached to and extend from the discharge conduit 226 of the water delivery portion 220 of the system 200, or may be formed integrally therewith. Water mist (shown as little circles) is shown being ejected from the flexible extension tube 227. The water mist, thus formed, may suppress powder aeration, or reduce powder overspray.

With the tip component 210, water source component 220 and splitter component 240 connected as shown (to the adapter 230), abrasive material and water may simultaneously be applied (ejected) onto a common target, such as patient's tooth.

As shown, a distal end (right, as viewed) of the flexible extension tube 227 may be positioned (with a clip, or the like, not shown) closely adjacent a distal end (right, as viewed) of the flexible extension tube 217. The relative positions of the distal ends of the two extension tubes may be adjusted by the user (dentist) to provide optimal delivery (including mixing) of abrasive and water. In this manner, the discharge conduit of the air abrasive device provides abrasive from the mixing chamber to the target (such as 40 (FIGS. 1A,B), which may be a surface of a patient's tooth. The flexible tube having its distal end in close proximity to the distal end of the gas (with abrasive) delivery conduit may simultaneously provide water from the water source to a common area of the target.

Alternatively, an additional component such as the overlay water nozzle described hereinbelow (refer to FIGS. 5A,B) may be used in order to keep the distal ends of the abrasive delivery tube 217 and water delivery tube 227 positioned close to one another.

The diameter of the discharge conduit 226 and extension (water delivery) tube 227 may be such that the water does not form droplets, but rather is delivered as a mist. And the abrasive delivery tube 217 and water delivery tube 227 may be positioned so that the powder (abrasive) and water (mist) do not mix with one another.

The water source component 220 eliminates the need for (and disadvantage of) using a dental chair water source with its associated valve arrangement and pressure regulator. The reservoir 224 contains sufficient water for performing a single dental procedure, and the diameter and length of the discharge conduit 226 and flexible extension 227 (which may collectively be referred to as a “micro-tube”) may be such that the micro-tube generates appropriate back pressure for controlling water dispensing at a preset pressure.

With reference to FIGS. 1A and 1B, in the manner that the discharge conduit 10 is movable to allow for selective delivery of abrasive from the micro-abrasive blasting device, the discharge conduit 226 of the water source component 220 may be movable to allow for selectively sealing water within the reservoir 224 and allowing water to be discharged from the reservoir. The plunger 228 prevents water from escaping from the delivery conduit 222 of the water source component, such as during shipping.

The water supply component 220, which may be referred to as a “water cartridge” may be pre-filled, and a new one may be used for each patient. The water contained in the reservoir can be flavored, which may be easier than flavoring the abrasive powder in the mixing chamber 214. The water cartridge can also be warmed up prior to use in order to reduce sensitivity.

The system may operate at a pressure of approximately 40-45 psi. There may be approximately 2-20 cc of water in the water cartridge, depending on the procedure. There may be approximately ½-2 grams of abrasive in the mixing chamber 214.

The use of a syringe for the water supply may, at first, seem counterintuitive. Medical syringes typically have a relatively small diameter, and a relatively long length. A syringe used for the water supply may have a relatively large diameter, and a relatively short length. A large volume of water is not required. Only a few drops of water may be needed to suppress powder aeration.

The flexible tube 227 may connect to the syringe 224 through a connector, such as a Luer-to-Barb connector, passing trough a pinch-valve flow control (not shown) to mount to the abrasion/polishing device nozzle. The Luer-to-barb connection can be a single coupler that is easily discarded.

The Luer taper is a standardized system of small-scale fluid fittings used for making leak-free connections between a male-taper fitting and its mating female part on medical and laboratory instruments, including hypodermic syringe tips and needles or stopcocks and needles. Currently ISO 80369 governs the Luer standards and testing methods.

Plastic Luer-to-Barb Fittings feature a hose barb connection and a male or female luer connection. Materials include but are not limited to White Nylon, Black Nylon, Natural Polypropylene, Clear Polycarbonate and Natural Kynar.

It is recognized that operating the system in this manner, with compressed air, although ideal for delivering abrasive in a stream of air, may present difficulties in controlling the flow of water, without additional complications. Therefore, some truly “self-contained” water delivery systems will be described.

The water reservoir (syringe) does not have to be mounted (by a bracket) to the air abrasion device. Rather, the water reservoir can be located elsewhere (remotely) with a longer (flexible) tube. The water reservoir does not have to be a syringe. It can be any water container that has exposure to atmospheric pressure including (for example) an IV (intravenous) bag type of reservoir. The bag would be thin and flexible, and may be filled, or partially filled with 2-20 ml of water. The bag does not need a vent. When water exits the bag, it will collapse (proportionally) due to atmospheric pressure.

A splitter component 240 has been shown for providing compressed air from the dental chair to both the abrasive component 210 and the water supply component 220. It is also possible, and within the scope of the invention to eliminate the splitter component 240 and supply the compressed air only to the abrasive component 210. In such a case, and with distal ends of the water supply tube 227 and the air/abrasive supply tube 217 in close proximity with one another, air exiting the distal end (tip) of the air/abrasive supply tube 217 may cause a pressure drop at the nearby distal end (tip) of the water supply tube sufficient to cause a small amount of water to be expelled from the water supply tube 227. Reference Bernoulli. This has the advantage that water is expelled only when, and in synchronization with, water/abrasive being delivered to the target (tooth) being treated. An example of relying on the pressure drop to control water delivery is shown and discussed in the FIG. 3 embodiment.

FIG. 3 illustrates an air-abrasive water suppression system 300 for performing a dental procedure on a patient. The system generally comprises:
a “tip” component 310 for delivering abrasive material; and
a water source component 320 for delivering water.

The tip component 310 may be substantially the same as the tip component 210 of the previous embodiment. Elements numbered 3 ## may be identical to elements numbered 2 ##.

The water source component 320 is different than the water source component 220 of the previous embodiment. Both contain water, but the water source component is not mounted to the tip component 310. Rather, the water source component 320 is external to the tip component 310, it has its own water supply, and it is not connected with and operates independently from chair-side compressed air or water. The water source is described in greater detail hereinbelow.

The “tip” component 310 may correspond to the micro-abrasive dental blasting device 75 described hereinabove and may comprise:
a gas delivery conduit 312 (corresponding to delivery conduit 30, hereinabove);
a mixing chamber 314 (corresponding to mixing chamber 23, hereinabove); and
a discharge conduit 316 (corresponding to discharge conduit 10, hereinabove).

There is no splitter 240 (including elements 242, 244 and 246) in this embodiment. The water supply 320 operates independently of chair air.

The gas delivery conduit 312 receives compressed air from a chairside source (not shown), and provides pressurized air to the mixing chamber, which may be at least partially filled with a quantity of abrasive powder (shown as little black dots in the mixing chamber). When the powder is aerated, it may be discharged through the discharge conduit, such as onto a patient's tooth (not shown).

The discharge conduit 316 may be movable to selectively seal abrasive powder within the mixing chamber or allow the abrasive powder to exit the mixing chamber, as described above with respect to FIGS. 1A and 1B.

The tip component 210 may attach directly via its gas delivery conduit to an adaptor (not shown, compare adaptor 230 in FIG. 2, and handheld supply connector 55 in FIG. 1C) which receives pressurized air from a pressurized air source (not shown) associated with a dental chair (not shown). The arrow (pointing left) at the gas delivery conduit 312 indicates air flow.

Flow of pressurized air from the air source, through the tip component 310 may be controlled (regulated) by a chair foot pedal (not shown).

The mixing chamber 314 may be pre-filled with non-abrasive polishing powders such as described above with respect to FIG. 2.

Generally, the system 300 may provide for full mouth waterless prophy treatment, as described with respect to the system 200 of FIG. 2, the main difference being in the water source component being self-contained, and not relying upon or interacting with a chair-side supply of either water or compressed air.

A flexible extension tube 317 may be attached to and extend from the discharge conduit 316 of the mixing chamber 314 of the abrasive delivery portion 310, or may be formed integrally therewith. Abrasive material (shown as little dots) is shown being ejected from the flexible extension tube 317.

### Water Source Component

The water source component 320 may be used in conjunction with the tip component 310 to deliver water during treatments with abrasive material, and may comprise:
a fluid reservoir 324; and
a discharge conduit 326.

The fluid reservoir 324 may be at least partially filled with a volume of water (“water”), and may be in a form similar to an IV Bag, and may be hung at a convenient location on the dentist chair.

A flexible extension tube 327 (or micro-tube) may be attached to and extend from the discharge conduit 326 of the water delivery portion 320 of the system 300, or may be formed integrally therewith. Water mist (shown as little circles) is shown being ejected from the flexible extension tube 327. The water mist, thus formed, may suppress powder aeration, or reduce powder overspray.

In this embodiment (as well as in the embodiment described with respect to FIG. 4) pressurized air is not required to cause water to be discharged from the discharge conduit 326. In this regard, the system 300, namely the water portion 320 (i.e., reservoir 324) thereof, may be considered to be “fully” self-contained since the water portion 320 does not require or utilize externally-supplied air pressure to operate.

Generally, gravity and/or air flowing out of the tip component 310 may cause water to flow out of the water source 320, due to a drop in air pressure related to the velocity of the air exiting the air/abrasive component 310. Again, reference is made to Bernoulli.

With the tip component 310, water source component 320 interacting as shown, abrasive material and water may simultaneously be applied (ejected) onto a common target, such as patient's tooth.

A distal end (right, as viewed) of the flexible extension tube 327 may be positioned (with a clip, or the like, not shown) closely adjacent a distal end (right, as viewed) of the flexible extension tube 317. The relative positions of the distal ends of the two extension tubes may be adjusted by the user (dentist) to provide optimal delivery (including mixing) of abrasive and water. In this manner, the discharge conduit of the air abrasive device provides abrasive from the mixing chamber to the target (such as 40, FIGS. 1A,B), which may be a surface of a patient's tooth. The flexible tube having its distal end in close proximity to the distal end of the gas (with abrasive) discharge conduit may simultaneously provide water from the water source to a common area of the target.

As mentioned previously (with respect to FIGS. 1A,B), the discharge conduit of the micro-abrasive device may be movable to selectively allow and block abrasive material from leaving the mixing chamber. When the discharge conduit is moved to a position blocking abrasive material from mixing air and exiting the mixing chamber (and discharge outlet), the air-abrasive device may deliver only air, and water may also be delivered.

Alternatively, an additional component such as an overlay water nozzle, described hereinbelow, (refer to FIGS. 5A,B) may be used in order to keep the distal ends of the abrasive delivery tube 317 and water delivery tube 327 positioned close to and in a predetermined relationship with one another.

The diameter of the discharge conduit 326 and extension (water delivery) tube 327 may be such that the water does not form droplets, but rather is delivered as a mist. And the abrasive delivery tube 317 and water delivery tube 327 may be positioned so that the powder (abrasive) and water (mist) do not mix with one another. Or, the abrasive delivery tube 317 and water delivery tube 327 may be positioned so that the powder (abrasive) and water (mist) mix with one another.

As with the previous embodiment (FIG. 2), the water source component 320 eliminates the need for (and disadvantage of) using a dental chair water source with its associated valve arrangement and pressure regulator. The reservoir 324 contains sufficient water for performing a single dental procedure, and the diameter and length of the discharge conduit 326 and flexible extension 327 (which may collectively be referred to as a “micro-tube”) may be such that the micro-tube 317 generates an appropriate pressure drop (or back pressure) for controlling water dispensing at a predetermined pressure.

The water supply component 320 may be pre-filled, and a new one may be used for each patient. The water contained therein can be flavored, which is easier than flavoring the powder. The water cartridge can also be warmed up prior to use in order to reduce sensitivity.

The system may operate at a pressure of approximately 40-45 psi. There may be approximately 2-20 cc of water in the water supply component 320, depending upon the procedure. There may be approximately ½-2 grams of abrasive in the mixing chamber 314.

When there is no air flow exiting the air abrasion/polishing unit, water in the water reservoir 320 is at equilibrium (atmospheric pressure). However, when air flow is present, the air flow generates a pressure drop at the water reservoir outlet. Since the atmospheric pressure on the water in the reservoir becomes higher than the pressure at the water reservoir outlet, the water in the reservoir will move (be sucked) out of the water reservoir outlet. The water droplets are then picked-up by the air steam exiting the discharge conduit to surround the powder particles thereby suppressing their aeration.

FIG. 4 shows a disposable water suppression system comprising an air abrasion device containing abrasive and a cartridge containing water at atmospheric pressure. The cartridge containing water may be mounted in any suitable manner, such as by a bracket to the air abrasion device.

The cartridge containing water, which may be referred to as a water supply or reservoir, may be similar to a medical syringe. Generally, a syringe is a simple reciprocating pump consisting of a plunger (or piston) that fits snugly tightly within a cylindrical tube (barrel). The plunger is movable within the barrel, allowing the syringe to take in or expel liquid (or gas) through a discharge orifice at the front end of the barrel. FIG. 2 also illustrated a water supply in the form of a syringe.

Generally, the WATER SUPPRESSION SYSTEM FOR DENTAL AIR-PARTICLE SURFACE TREATMENT SYSTEMS of the present invention comprises a source of water which may be contained, for example, in a syringe (or reservoir). The water can be flavored, sterile, and/or medicated for subgingival procedures-contain antibiotics or numbing agent.

An air-abrasive water suppression system 400 for use in conjunction with a (dental) air abrasion system (device) having a tip for discharging an abrasive may comprise:
an air abrasion device 402 having a discharge conduit (nozzle, tip) 403;
a cartridge 404 (such as a syringe) containing a supply (reservoir) of fluid (water) at atmospheric pressure and having an outlet (discharge orifice) 405; and
an elongate flexible water-delivery tube 406, a proximal end of which is connected (in fluid communication) with the outlet 405 of the cartridge (such as by slipping over the outlet) to receive water from the cartridge, a distal end of which extends to or past a distal end of the discharge conduit 403 of the air abrasion device 402;
wherein the distal end of the discharge conduit 403 of the air abrasion device 402 may be inserted into the flexible water-delivery tube 406 at a point near the distal end of the tube such that the tube surrounds the distal end of the discharge conduit 403; and
wherein when air (containing abrasive) is discharged from the air abrasion device a negative (less than atmospheric) pressure is created (venturi effect) in the flexible tube causing water to be discharged (sucked) from the cartridge through the flexible tube and mixed with the airborne abrasive exiting the tip of the abrasion device.

In this manner, the discharge conduit of the air abrasive device provides abrasive from the mixing chamber to the target (such as 40, FIGS. 1A,B), which may be a surface of a patient's tooth. The flexible tube having its distal end in close proximity to the distal end of the gas (with abrasive) discharge conduit may simultaneously provide water from the water source to a common area of the target.

The water-containing cartridge 404 may be a standard 25 ml or 100 ml plastic syringe. The plunger of the syringe may have a diameter of 20 mm. The suction created by the air exiting the air abrasion device is sufficient to move the plunger in the syringe causing water to be discharged from the discharge orifice at the front end of the syringe barrel. Generally, the suction force will be more prominent with syringes having a larger diameter plunger. In other words, the force on the plunger is proportional to the diameter of the plunger.

The flexible tube may be a plastic material such as PVC, PTFE or the like, having an ID of 1/16 inch (0.0625 inch, 1.6 mm) or ⅛ inch (0.125 inch, 3 mm) and a length of approximately 2 inches (50 mm).

The point near the distal end of the tube at which the tip (nozzle) of the air abrasion system is inserted into the flexible tube may be located approximately 4-5 mm (0.16-0.20 inch) from the distal end of the flexible tube.

The water suppression system may further comprise a clamp 407 may be disposed along the length of the flexible tubing 406, between the outlet of the cartridge (syringe) and the point where the distal end of the discharge conduit of the air abrasion device is inserted into the flexible tube, said clamp being adjustable to control (regulate) the flow (amount) of water exiting the distal end of the flexible tube, thereby creating a water mist accompanying the airborne abrasive exiting the abrasion system. The clamp 407 may function by pinching the tube 406, thereby regulating (reducing or shutting off) water coming from the cartridge 404.

The clamp 407 may comprise a block of plastic through which the flexible tubing passes and a thumbscrew, an end of which radially contacts the flexible tubing, for selectively pinching (closing) the flexible tubing a desired amount (from fully “open”, through partially “open”, to fully “closed”). Other types of clamps may be used to pinch off the flexible tubing and regulate the flow of water exiting the distal end of the flexible tubing.

The system takes advantage of the venturi effect, utilizing a pressure drop due to air exiting the air abrasion device 402 to create a pressure drop across the water reservoir outlet of the flexible tube 406 mounted over the distal end of the discharge conduit 403, resulting in water being delivered in conjunction with the air (and abrasive material) being ejected (sprayed) by the air abrasion/polishing unit.

FIGS. 5A,B are illustrations of an “overlay water nozzle” or “tube attachment” component, the purpose of which is to facilitate reliable placement and secure mounting of the water delivery tube (hose) coming from the water supply (whether external or self-contained) and the discharge conduit (nozzle) of the device supplying abrasive material and air to ensure appropriate positioning of water to suppress the aeration of expressed powders during delivery.

The overlay water nozzle 500 is shown as being mounted over the air abrasive nozzle. The overlay water nozzle may be made of plastic, hollow, and may support a barb type connection for mounting the water delivery tube (hose).

More particularly, as shown, the overlay water nozzle may be generally Y-shaped, having two inlets 502, 504 and one outlet 506.

The discharge conduit (labeled “air abrasive nozzle”) of a micro-abrasive blasting device (not shown) is shown inserted through the inlet 502 of the overlay water nozzle, passing through the overlay water nozzle directly (in a straight line) towards the outlet 506.

The discharge conduit may extend (as shown) nearly to the outlet end of the overlay water nozzle. Alternatively, the discharge conduit may extend (as shown) to the outlet end of the overlay water nozzle. Or, the discharge conduit may extend (as shown) beyond the outlet end of the overlay water nozzle.

The water delivery tube (not shown) from the water supply may be inserted into (or onto) the inlet 504 of the overlay water nozzle.

The inside diameter (ID) of the overlay water nozzle may be slightly larger than the outside diameter (OD) of the discharge conduit of a micro-abrasive blasting device to allow water from the water delivery tube pass through the outlet portion of the overlay water nozzle and to exit the outlet 506 of the overlay water nozzle via a small gap (clearance) between the discharge conduit and interior of the overlay water nozzle. This is indicated as “water & air” exiting the overlay water nozzle.

While the invention(s) has/have been described with respect to a limited number of embodiments, these should not be construed as limitations on the scope of the invention(s), but rather as examples of some of the embodiments. Those skilled in the art may envision other possible variations, modifications, and implementations that are also within the scope of the invention(s), based on the disclosure(s) set forth herein.

What is claimed is:

1. An air-abrasive water suppression system comprising;
an air-abrasion device comprising:
a mixing chamber containing abrasive material;
a gas delivery conduit for providing pressurized air to the mixing chamber;
a discharge conduit for providing the abrasive material mixed with the pressurized air from the mixing chamber to a target;
further comprising;
a water source comprising:
a tube for providing water from the water source to the target.

2. The air-abrasive water suppression system of claim 1, wherein:
a distal end of the tube for providing water is maintained in close proximity to a distal end of the discharge conduit providing the abrasive material.

3. The air-abrasive water suppression system of claim 1, wherein:
the discharge conduit is movable to selectively allow and block abrasive material from leaving the mixing chamber.

4. The air-abrasive water suppression system of claim 1, wherein:
the water source is in the form of a having a length, a diameter and two opposite ends—an inlet end and an outlet end;
further comprising:
a rubber plunger disposed inside the cylinder and capable of bi-directionally between the two opposite ends of the cylinder;
wherein:
the inlet end is adapted to receive pressurized air from an external source; and
the water source tube is in fluid communication with the outlet end of the water source to discharge water contained within the water source.

5. The air-abrasive water suppression system of claim 4, wherein:
the water source tube is flexible and is connected to the outlet end of the water source; and
further comprising:
a flexible extension tube in fluid communication with the discharge conduit of the mixing chamber.

6. The air-abrasive water suppression system of claim 4, wherein:
a splitter component having one inlet and two outlets disposed in the system such that pressurized air supplied to the inlet of the splitter component may be directed to the two outlets of the splitter component.

7. The air-abrasive water suppression system of claim 6, wherein:
the delivery conduit of the air abrasion device is adapted to receive pressurized air from the outlet of the splitter component; and
the inlet end of the water source is adapted to receive pressurized air from the outlet (246) of the splitter component.

8. The air-abrasive water suppression system of claim 1, wherein the water source comprises:
a fluid reservoir; and
a discharge conduit.

9. The air-abrasive water suppression system of claim 8, further comprising:
a flexible extension tube extending from an end of the discharge conduit for directing the abrasive material mixed with the pressurized air from the mixing chamber to the target; and
the tube for providing water to the target is a flexible tube.

10. The air-abrasive water suppression system of claim 1, further comprising:
an overlay water nozzle for maintaining a distal end of the tube for providing water from the water source in close proximity to a distal end of the discharge conduit providing the abrasive material from the mixing chamber.

11. A method of performing a dental procedure comprising:
directing a stream of pressurized air mixed with abrasive material from a handheld air-abrasion device through a discharge conduit having a distal end directed at a target; and
dispensing water in close proximity with the abrasive material exiting the discharge conduit to generate a water mist for suppressing powder aeration at and around the target;
wherein the target is a surface of a tooth.

12. The method of claim 11, wherein:
the stream of pressurized air mixed with abrasive material can selectively be switched on and off.

13. The method of claim 11, wherein:
water dispensing is caused by the pressurized air supplied to the air-abrasion device.

14. The method of claim 11, wherein:
water dispensing is caused by the stream of pressurized air mixed with abrasive material exiting the handheld air-abrasion device.
